(19) United States
(12) Patent Application Publication
(10) Pub. No.: US 2013/0057446 A1
(43) Pub. Date: Mar. 7, 2013

(54) ANTENNA DEVICE AND PORTABLE WIRELESS TERMINAL EQUIPPED WITH THE SAME

(71) Applicants: Takanori Hirobe, Ishikawa (JP); Tomoaki Nishikido, Ishikawa (JP); Hiroshi Satou, Kanagawa (JP); Yoshio Koyanagi, Kanagawa (JP)

(72) Inventors: Takanori Hirobe, Ishikawa (JP); Tomoaki Nishikido, Ishikawa (JP); Hiroshi Satou, Kanagawa (JP); Yoshio Koyanagi, Kanagawa (JP)

(73) Assignee: PANASONIC CORPORATION, Osaka (JP)

(21) Appl. No.: 13/698,178

(22) PCT Filed: May 16, 2011
(86) PCT No.: PCT/JP2011/002715

§ 371 Date: Nov. 15, 2012

(30) Foreign Application Priority Data
May 17, 2010 (JP) 2010-112851

(51) Int. Cl. H01Q 1/52

(52) U.S. Cl. 343/851

(57) ABSTRACT

A first connection circuit 114 is adjusted to cancel the impedance of the mutual coupling between a first antenna element 150 and a second antenna element 151 in the range from the first frequency band to the second frequency band, thereby reducing degradation in the coupling between the antenna elements. With such a configuration, it is possible to achieve high-efficiency loosely coupled antennas operating in the same wide frequency band in a portable wireless terminal.

### TECHNICAL FIELD

The present invention relates to an antenna device and a portable wireless terminal equipped with the same. In particular, the present invention relates to an array antenna for a portable terminal, and which achieves broadband with two elements.

### BACKGROUND ART

Portable wireless terminals such as mobile phones have been developed to have more and more functions, for example, not only the telephone function, the electronic mail function, and the function of access to the Internet, but also the near-field wireless communication function, the wireless LAN function, the GPS function, the TV-viewing function, the IC card transaction function, and the like. In addition, in cellular communication, as a technique for achieving a high-speed and high-capacity wireless communication system, it can be expected to provide spatial multiplexing transfer (MIMO: Multi-Input Multi-Output) for performing communication by using a plurality of antennas on the transmission side and the reception side. In this technique, the spatial multiplexing is performed by transmitting the same signals which are space-time coded from a plurality of transmission antennas in the same band, and information is extracted by receiving the signals through a plurality of reception antennas and separating the signals. Thereby, the transfer speed is improved, and thus it becomes possible to perform high-capacity communication. As the number of functions thereof increases, the number of antennas mounted in the portable wireless terminal tends to increase. Thus, there is a serious problem in that degradation in the antenna performance is caused by coupling between the plurality of antenna elements.

On the other hand, from the viewpoint of design and mobility, it is desired that the portable wireless terminal be made smaller and more highly integrated. In order to maintain favorable antenna characteristics while achieving reduction in size of the device, it is necessary to study the arrangement of antenna elements and coupling between the antenna elements in various ways. Further, a high-performance antenna system, which is subject to the coupling degradation countermeasures by reducing the number of power supply paths and the number of antenna elements as much as possible, is required.

As the existing portable wireless device coping with the problem of the coupling between the antenna elements, for example, as disclosed in PTL 1 and NPL 1, there is a known configuration in which low correlation between antennas is achieved by connecting the power supply sections of the array antenna elements through a connection circuit inserted therebetween so as to cancel the mutual coupling impedance between antennas.

### CITATION LIST

### Patent Literature

[PTL 1] US2008-A-0258991 (for example, FIG. 6A)

[PTL 2] Pamphlet of International Publication WO 09/113142

### Non Patent Literatures

[NPL 1] “Decoupling and descattering networks for antennas”, IEEE Transactions on Antennas and Propagation, vol. 24 Issue 6, November 1976

### SUMMARY OF INVENTION

### Technical Problem

However, in the existing configuration disclosed in PTL 1 and NPL 1, the connection element 606 is operated to form current distribution in which the phase of the coupling between elements is inverted. Thus, there is a problem in that the system is intrinsically a narrow band system. For this reason, in order to be compliant with multiple bands for which a cellular antenna system for current communication is necessary, it is necessary to provide a plurality of antenna elements or a connection element for each frequency and feed a voltage to each of them. Thus, there is a problem in that the configuration thereof becomes complicated.

Further, in the existing configuration disclosed in PTL 2, by adopting a box structure in a similar manner as the antenna element 5, broadband characteristics are achieved. However, there is no description about the loose coupling technique which is necessary to achieve MIMO.

In the present invention, in order to solve the above-mentioned problem, the portable wireless terminal, on which two or more antenna elements for MIMO and the like are mounted in an array, is configured such that rectangular parallelepiped antenna elements formed by folding flat plates are connected through a connection circuit. With such a configuration, an object is to provide an array antenna device, which is capable of achieving wider band characteristics than hitherto, and a portable wireless terminal equipped with the same.

### Solution to Problem

An antenna device of the present invention includes: a casing; a circuit board that is provided in the casing and has a ground pattern; a first antenna element that includes a first conductor plate which is disposed in and near the casing and is conductive and substantially rectangular, a second conductor plate which shares one side of the first conductor plate in a widthwise direction thereof, is disposed on the first conductor plate at approximately 90 degrees, and is substantially rectangular, and a third conductor plate which shares the other side in the widthwise direction opposed to the one side of the second conductor plate shared with the first conductor plate, is disposed at approximately 90 degrees so as to be opposed to the first conductor plate, and is substantially rectangular, and that is supplied with electric power substantially from a corner of the circuit board; a second antenna element that includes a fourth conductor plate which is disposed in and near the casing and) is conductive and substantially rectangular, a fifth conductor plate which shares one side of the fourth conductor plate in a widthwise direction thereof, is disposed on the fourth conductor plate at approximately 90 degrees, and is substantially rectangular, and a sixth conductor plate which shares the other side in the widthwise direction opposed to the one side of the fifth conductor plate shared with the fourth conductor plate, is disposed at approximately 90 degrees so as to be opposed to the fourth conductor plate, and is substantially rectangular, and that is supplied with electric power substantially from a corner of the circuit board; and a connection circuit that electrically interconnects the first antenna element and the second antenna element. The first antenna element and the second antenna element are disposed to be close to each other at a predetermined distance away from the ground pattern on the circuit board, and are electrically connected to a first power supply section and a second power supply section which are disposed at end portions of the circuit board. The connection circuit is adjusted to cancel an impedance of mutual coupling between the first antenna element and the second antenna element in a range from a first frequency band to a second frequency band.

With such a configuration, it is possible to achieve an array antenna which has wider band frequency characteristics than hitherto.

Further, in the antenna device of the present invention, the first antenna element is electrically connected to the first power supply section through a first impedance matching circuit, and the second antenna element is electrically connected to the second power supply section through a second impedance matching circuit.

With such a configuration, in the desired frequency band, it is possible to achieve looser-coupled-antenna characteristics.

Further, in the antenna device of the present invention, a part or the entirety of either one or both of the first antenna element and the second antenna element is formed as a copper foil pattern on a printed-circuit board.

With such a configuration, the antenna elements can be disposed with high accuracy, and thus it is possible to achieve an array antenna advantageous in mass production.

Further, in the antenna device of the present invention, either one or both of the first antenna element and the second antenna element is formed of a substantially cylindrical conductor.

With such a configuration, it is possible to achieve an array antenna which operates in a wider frequency band than hitherto.

Further, the antenna device of the present invention is mounted on a portable wireless terminal.

With such a configuration, it is possible to improve the antenna characteristics of the portable wireless terminal, and thus it is possible to reduce the size of the portable wireless terminal.

Further, the antenna device of the present invention is mounted on a MIMO-capable portable wireless terminal.,

With such a configuration, it is possible to improve the antenna characteristics of the MIMO-capable portable wireless terminal, and thus it is possible to reduce the size thereof.

### Advantageous Effects of Invention

In the antenna device of the present invention and the portable wireless terminal equipped with the same, it is possible to achieve a loosely coupled array antenna device, which operates in a broadband, and a portable wireless terminal equipped with the same.

### BRIEF DESCRIPTION OF DRAWINGS

FIGS. 1(a) to 1(c) are configuration diagrams of a portable wireless terminal according to Embodiment 1 of the present invention.

FIGS. 2(a) to 2(e) are diagrams illustrating specific configurations of connection circuits according to Embodiment 1 of the present invention.

FIGS. 3(a) to 3(c) are diagrams illustrating a characteristic analysis model of the portable wireless terminal according to Embodiment 1 of the present invention.

FIGS. 4(a) to 4(c) are characteristic diagrams of the portable wireless terminal according to Embodiment 1 of the present invention.

FIGS. 5(a) and 5(b) are diagrams illustrating analysis conditions (1 to 3) according to Embodiment 1 of the present invention.

FIGS. 6(a) to 6(c) are characteristic diagrams of the portable wireless terminal on the analysis conditions (1 to 3) according to Embodiment 1 of the present invention.

FIG. 7 is a configuration diagram of a portable wireless terminal according to Embodiment 2 of the present invention.

FIG. 8 is a configuration diagram of a portable wireless terminal according to Embodiment 3 of the present invention.

FIG. 9 is a configuration diagram of the existing loosely coupled array antenna.

### DESCRIPTION OF EMBODIMENTS

Hereinafter, embodiments of the present invention will be described with reference to drawings.

### Embodiment 1

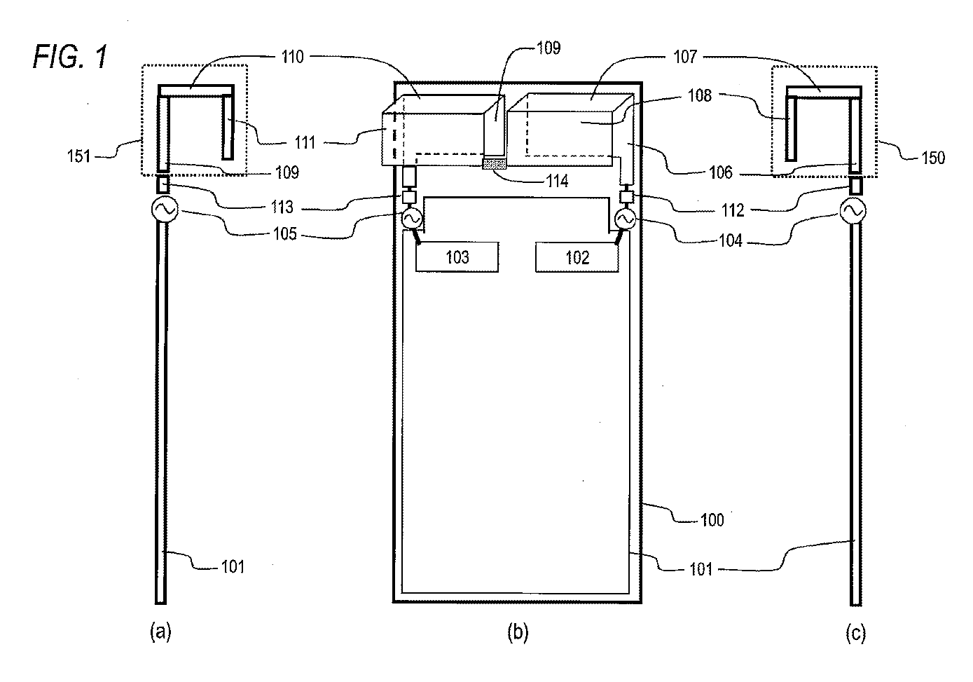

FIGS. 1(a) to 1(c) are configuration diagrams of a portable wireless terminal according to Embodiment 1 of the present invention. FIG. 1(a) is a configuration diagram of the portable terminal viewed from the left side, and FIG. 1(b) is a diagram showing a view from the front. Further, FIG. 1(c) is a configuration diagram showing a view from the right side.

As shown in FIGS. 1(a) to 1(c), a circuit board 101 disposed in the portable wireless terminal 100 includes a first wireless circuit section 102. Thus, a first antenna element 150 made of a conductive metal is supplied with a high-frequency signal through a first power supply section 104. Here, the first antenna element 150 includes: a first conductor plate 106 which is conductive and substantially rectangular; a second conductor plate 107 which shares one side of the first conductor plate 106 in a widthwise direction thereof, is disposed thereon at approximately 90 degrees, and is substantially rectangular; and a third conductor plate 108 which shares the other side in the widthwise direction opposed to the one side of the second conductor plate 107 shared with the first conductor plate 106, is disposed at approximately 90 degrees so as to be opposed to the first conductor plate 106, and is substantially rectangular. Furthermore, the circuit board 101 includes a second wireless circuit section 103. Thus, a second antenna element 151 made of a conductive metal is supplied with a high-frequency signal through a second power supply section 105. Here, the second antenna element 151 includes: a fourth conductor plate 109 which is conductive and substantially rectangular; a fifth conductor plate 110 which shares one side of the fourth conductor plate 109 in a widthwise direction thereof, is disposed thereon at approximately 90 degrees, and is substantially rectangular; and a sixth conductor plate 111 which shares the other side in the widthwise direction opposed to the one side of the fifth conductor plate 110 shared with the fourth conductor plate 109, is disposed at approximately 90 degrees so as to be opposed to the fourth conductor plate 109, and is substantially rectangular.

With such a configuration, each of the first antenna element 150 and the second antenna element 151 is able to obtain broadband frequency characteristics. However, in the first antenna element 150 and the second antenna element 151, the leading end portions of the elements are disposed substantially in parallel at a distance of 0.02 wavelengths or less from the center portion of the portable wireless terminal 100 in the widthwise direction. Hence, the high-frequency current, which flows in one antenna element due to the impedance of the mutual coupling between the antenna elements, flows as induced current in the other antenna element. As a result, the radiation performance of the antenna deteriorates.

Accordingly, there has been used means for reducing degradation in the coupling between the antenna elements by canceling the impedance of the mutual coupling between the antennas in the range from the first frequency band to the second frequency band by inserting a first connection circuit 114 such that it interconnects the end portions of the first antenna element 150 and the second antenna element 151.

Furthermore, the first antenna element 150 is connected to the first power supply section 104 through a first impedance matching circuit 112, and the second antenna element 151 is connected to the second power supply section 105 through a second impedance matching circuit 113. By arranging the first impedance matching circuit 112 and the second impedance matching circuit 113, it is possible to further minutely adjust the impedance matching of the first antenna element 150, the impedance matching of the second antenna element 151, and the impedance of the mutual coupling between the antenna elements. Thus, the effect that reduces coupling degradation further increases.

It should be noted that, in the configuration of FIGS. 1(a) to 1(c), although the first antenna element 150 and the second antenna element 151 are described as conductive metal components, a part or all of the elements may be formed as copper foil patterns formed on the printed-circuit board. Even in this case, it is possible to obtain the same effect.

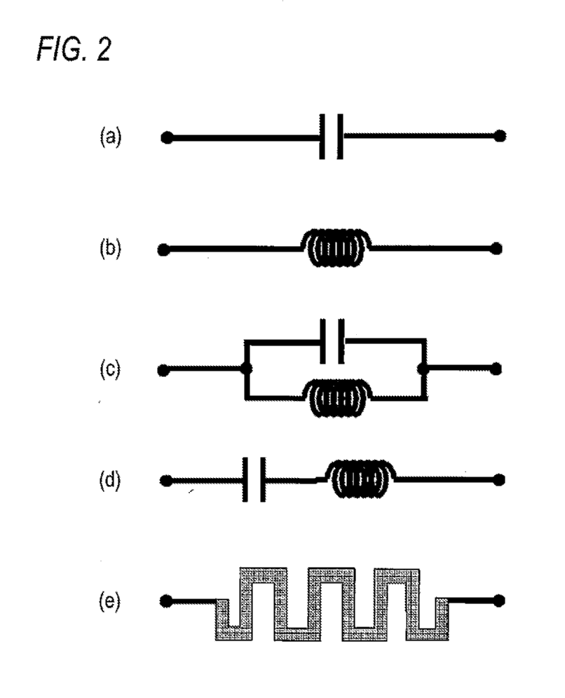

FIGS. 2(a) to 2(e) are diagrams illustrating specific configurations of the firs connection circuits according to Embodiment 1 of the present invention.

As shown in FIGS. 2(a) to 2(e), possible first connection circuits include: a capacitor shown in FIG. 2(a); an inductor shown in FIG. 2(b); a parallel resonance circuit shown in FIG. 2(c); a serial resonance circuit shown in FIG. 2(d); and a meander pattern shown in FIG. 2(e). Further, in other configurations, any configuration may be adopted as well if the configuration is a configuration in which an equivalent circuit such as a filter or a capacitor formed as a pattern can be represented by combination of capacitors or inductors and the mutual coupling impedance can be adjusted. Furthermore, it may be possible to adopt a configuration in which a plurality of the configurations are combined.

In addition, in the configuration of FIGS. 1(a) to 1(c), the mutual coupling between two antenna elements occurs. However, by disposing an impedance matching circuit, it is possible to integrally adjust such mutual coupling impedance. As a result, in the range from the first frequency band to the second frequency band, S parameters S12 and S21, which are pass characteristics between the first power supply section 104 and the second power supply section 105, can be suppressed to remain low. Thus, it is possible to reduce the coupling degradation.

Subsequently, a description will be given of an example in which the performance of the specific configuration of FIGS. 1(a) to 1(c) is analyzed.

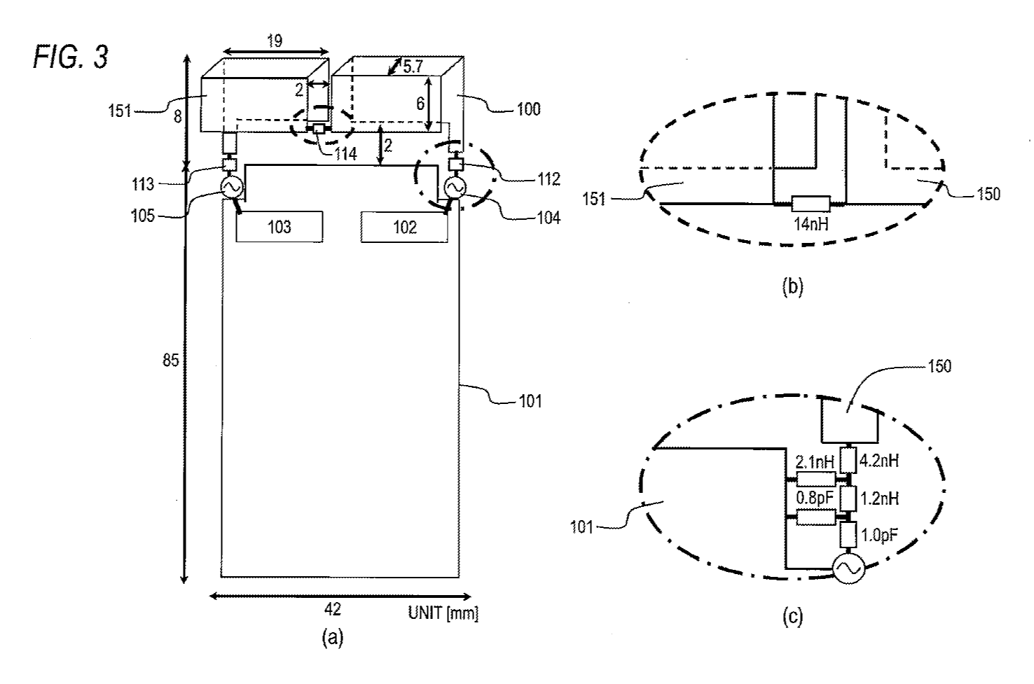

FIGS. 3(a) to 3(c) are diagrams illustrating a characteristic analysis model of the portable wireless terminal according to Embodiment 1 of the present invention. It should be noted that the portable wireless terminal has a bilaterally symmetrical structure and thus the drawing of the circuit configuration on the antenna element 151 side will be omitted.

As shown in FIG. 3(a), the circuit board 101 is formed as a printed-circuit board made of glass epoxy. However, the circuit board is modeled to be formed of a copper foil with a length of 85 mm and a width of 42 mm, and is analyzed. In the circuit board 101, the first antenna element 150 and the second antenna element 151 formed of conductive copper plates are supplied with the high-frequency signal through the first power supply section 104 and the second power supply section 105.

The high-frequency signals of 1 GHz to 3 GHz including the first frequency band of 1.74 GHz and the second frequency band of 2.15 GHz are supplied from the first power supply section 104 and the second power supply section 105, and analysis is performed on the pass characteristic S21 and the reflection characteristic S11, which are the S parameters, and the radiation efficiency.

The first antenna element 150 includes, on the same plane: the first conductor plate 106 which has a length of 6 mm and a width of 19 mm; the second conductor plate 107 which is disposed on the first conductor plate 106 at 90 degrees so as to share one side of the first conductor plate 106 in the widthwise direction and has a length of 5.7 mm and a width of 19 mm; and the third conductor plate 108 which is disposed to share the other side in the widthwise direction opposed to the one side of the second conductor plate 107 shared with the first conductor plate 106 and be opposed to the first conductor plate 106 and has a length of 6 mm and a width of 19 mm. On the other hand, the second antenna element 151 includes, on the same plane: the fourth conductor plate 109 which has a length of 6 mm and a width of 19 mm; the fifth conductor plate 110 which is disposed on the fourth conductor plate 109 at 90 degrees so as to share one side of the fourth conductor plate 109 in the widthwise direction and has a length of 5.7 mm and a width of 19 mm; and the sixth conductor plate 111 which is disposed to share the other side in the widthwise direction opposed to the one side of the fifth conductor plate 110 shared with the fourth conductor plate 109 and be opposed to the fourth conductor plate 109 and has a length of 6 mm and a width of 19 mm.

The first antenna element 150 and the second antenna element 151 are disposed at the end portions of the circuit board 101. The space between the parallel portions, which are closest to the first antenna element 150 and the second antenna element 151, is 2 mm, and is disposed to be a space extremely approximate to 0.01 wavelength at 1.74 GHz. The first antenna element 150 and the second antenna element 151 are disposed substantially in parallel at an extremely close distance. Hence, the high-frequency current, which flows in each antenna element due to the mutual coupling between the antenna elements, flows as induced current in the other antenna element. As a result, degradation in radiation performance of the antenna occurs. Accordingly, by inserting the first connection circuit 114 which interconnects the end portions of the first antenna element 150 and the second antenna element 151 so as to cancel an impedance of the mutual coupling between antennas at 1.74 GHz and 2.15 GHz, degradation in the coupling between the antenna elements is reduced. Furthermore, by disposing the first impedance matching circuit 112 and the second impedance matching circuit 113 at the origins of the respective antenna elements, it is possible to further minutely adjust the impedance matching of the first antenna element 150, the impedance matching of the second antenna element 151 and the impedance of the mutual coupling between the antenna elements. Thus, the effect that reduces coupling degradation further increases.

As shown in FIG. 3(b), an inductor of 14 nH is disposed as the first connection circuit 114 at the center thereof.

As shown in FIG. 3(c), the first impedance matching circuit 112 is disposed to be serial connection of 1.0 pF, 1.2 nH, and 4.2 nH arranged in this order from the first power supply section 104 side to the first antenna element 150, where 0.8 pF is set between 1.0 pF and 1.2 nH on the ground pattern of the circuit board, and 2.1 nH is set between 1.2 nH and 4.2 nH on the ground pattern of the circuit board, and is grounded. Likewise, the second impedance matching circuit 113 is also disposed to be serial connection of 1.0 pF, 1.2 nH, and 4.2 nH arranged in this order from the second power supply section 105 side to the second antenna element 151, where 0.8 pF is set between 1.0 pF and 1.2 nH on the ground pattern of the circuit board, and 2.1 nH is set between 1.2 nH and 4.2 nH on the ground pattern of the circuit board, and is grounded.

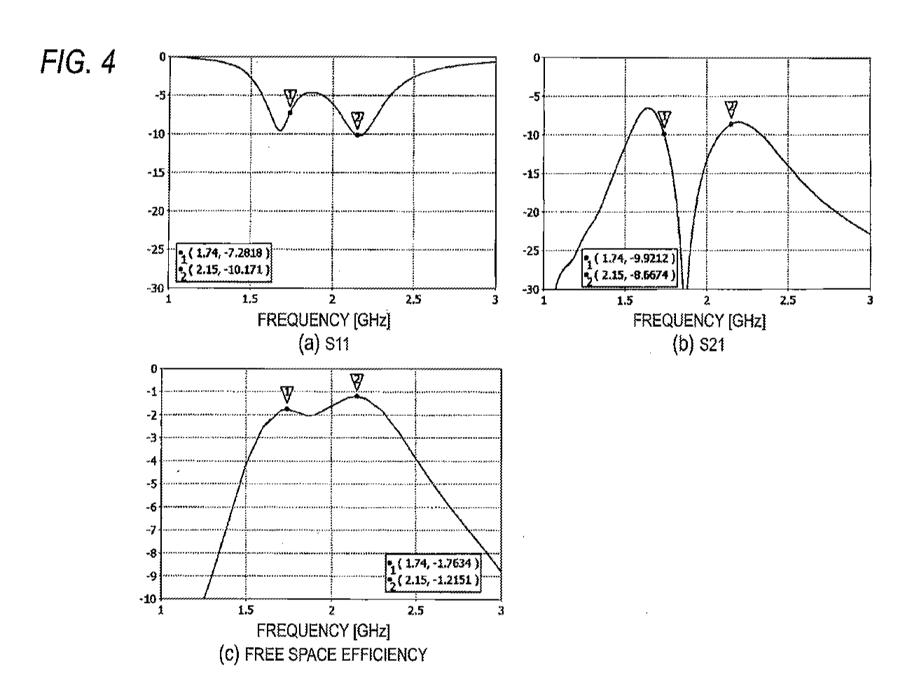

FIGS. 4(a) to 4(c) are characteristic diagrams which are analyzed by using the analysis models of FIGS. 3(a) to 3(c) according to Embodiment 1 of the present invention. FIG. 4(a) shows the S11 waveform viewed from the first power supply section 104. FIG. 4(b) shows the S21 waveform which has pass characteristics from the first power supply section 104 to the second power supply section 105. FIG. 4(c) shows the free space efficiency of the first antenna element 150. In each diagram, the horizontal axis indicates the characteristics of the frequency range from 1 GHz to 3 GHz.

As shown in FIG. 4(a), S11 in the range from 1.74 GHz to 2.15 GHz is a low value less than or equal to −5 dB, and thus it can be observed that the impedances are matched in this frequency band. Since the analysis models of FIGS. 3(a) to 3(c) are bilaterally symmetrical, S22 is also a low value less than or equal to −5 dB. Furthermore, as shown in FIG. 4(b), S21, which has pass characteristics in the range from 1.74 GHz to 2.15 GHz, is a low value less than or equal to −5 dB, and thus isolation is ensured in this frequency band, and it can be observed that the coupling degradation is reduced. As described above, in the range from 1.74 GHz to 2.15 GHz, it is possible to ensure the impedance matching and isolation. As a result, it can be observed that the coupling degradation is reduced. Further, as shown in FIG. 4(c), the free space efficiency in the range from 1.74 GHz to 2.15 GHz is greater than or equal to −2 dB, and thus it can be seen that it is possible to obtain high antenna efficiency.

As described above, according to the present Embodiment 1, in a wide frequency band ranging from the first frequency band to the second frequency band used by operating the first antenna element 150 and the second antenna element 151, it is possible to design a built-in array antenna capable of reducing coupling degradation.

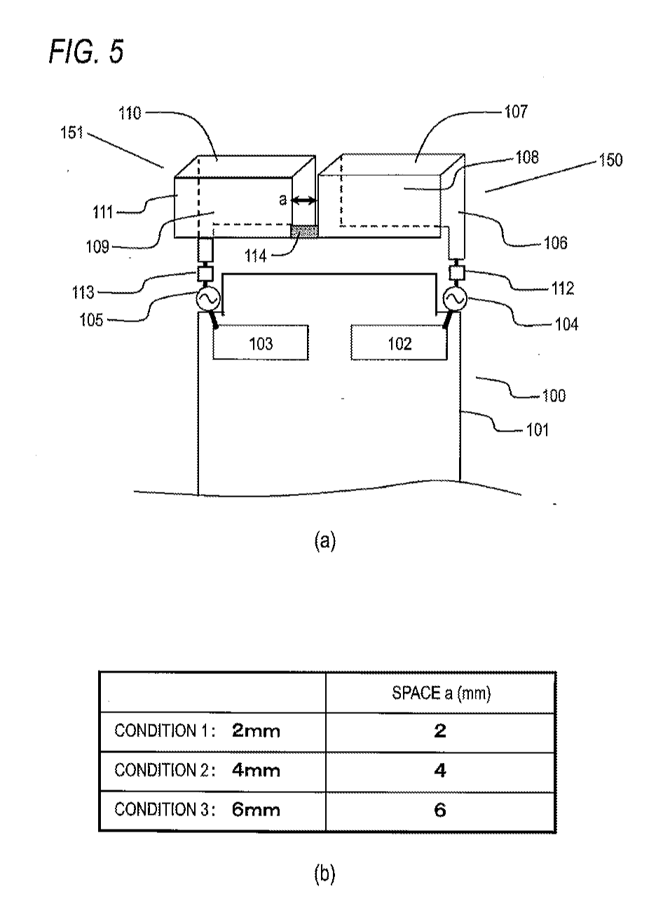

FIG. 5(a) is a configuration diagram of a case where the space between the leading end portions of the first antenna element 150 and the second antenna element 151 is set to a parameter “a” in Embodiment 1 of the present invention. Furthermore, FIG. 5(b) is a diagram illustrating an analysis condition in a case of changing the space a between the leading end portions of the first antenna element 150 and the second antenna element 151.

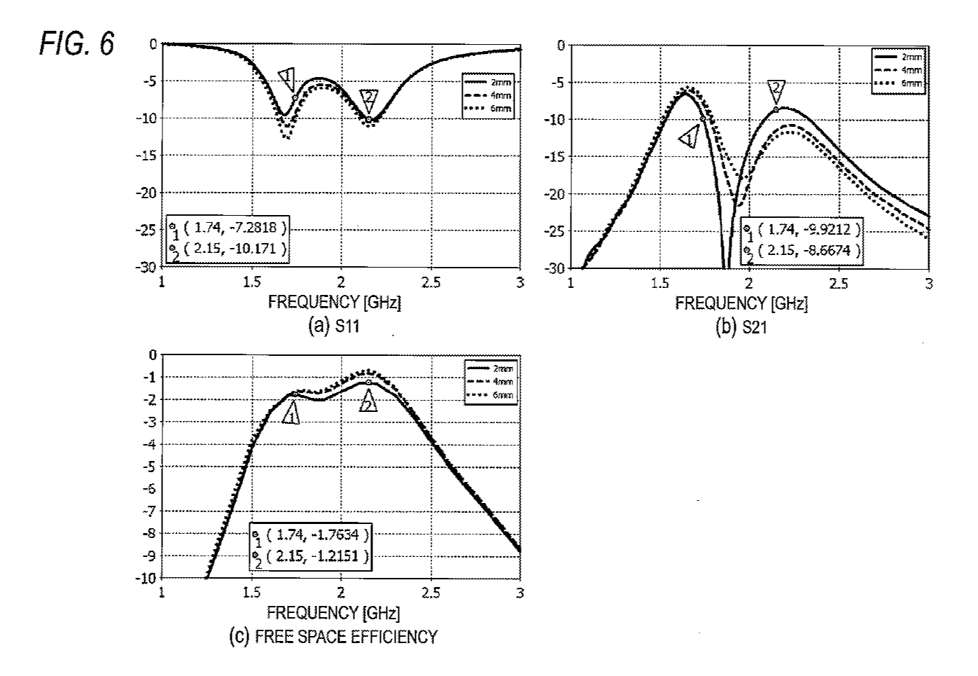

FIGS. 6(a) to 6(c) are characteristic diagrams which are analyzed by using the analysis models and analysis conditions of FIGS. 5(a) and 5(b). FIG. 6(a) shows the S11 waveform viewed from the first power supply section 104. FIG. 6(b) shows the S21 waveform which has pass characteristics from the first power supply section 104 to the second power supply section 105. FIG. 6(c) shows the free space efficiency of the first antenna element 150. In each diagram, the horizontal axis indicates the characteristics of the frequency range from 1 GHz to 3 GHz. Here, by changing the space a between the leading end portions of the first antenna element 150 and the second antenna element 151, it can be seen that various characteristics are changed. This shows presence of equivalent capacity formed between the leading end portions of the first antenna element 150 and the second antenna element 151. The equivalent capacity operates as a distribution constant which is parallel with the first connection circuit 114, and thus constitutes a broad circuit, which has a low Q value, in combination with the first connection circuit 114 as a lumped constant. By using the equivalent capacity, it is possible to minutely adjust the mutual coupling impedance characteristics. In addition, in the wide frequency band ranging from the first frequency band to the second frequency band used by operating the first antenna element 150 and the second antenna element 151, it is possible to design a built-in array antenna capable of reducing coupling degradation.

### Embodiment 2

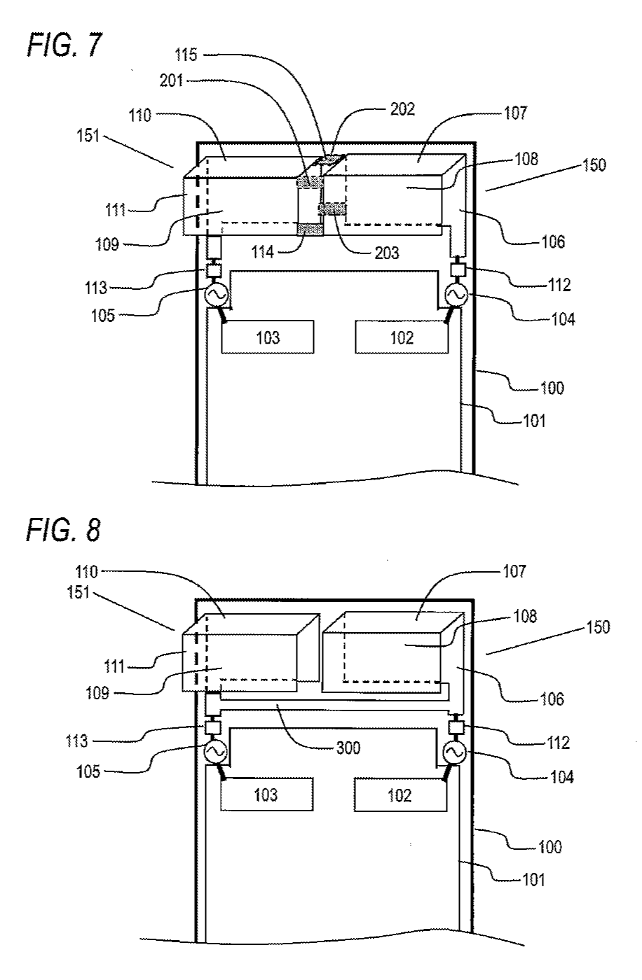

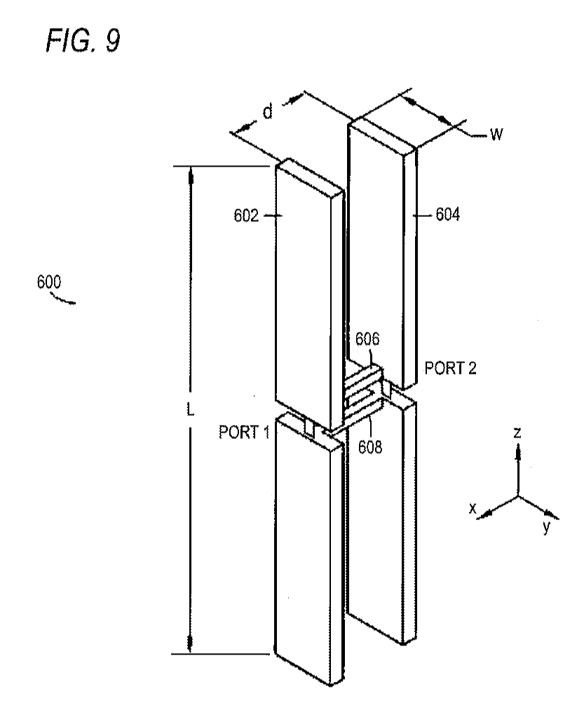

FIG. 7 is a configuration diagram of a portable wireless terminal according to Embodiment 2 of the present invention.

In FIG. 7, the components common to FIGS. 1(a) to 1(c) will be referenced by the same reference numerals and signs, and description thereof will be omitted.

In the portable wireless terminal shown in FIG. 7, the connection position of the first connection circuit 114, which interconnects the first antenna element 150 and the second antenna element 151, can be moved to any of a first connection position 201, a second connection position 202, and a third connection position 203. With such a configuration, a degree of freedom in design is improved. Further, for example as shown in FIG. 7, the second connection circuit 115 is disposed at the second connection position 202, whereby it is possible to further minutely adjust the impedance of the mutual coupling between the antenna elements. Thus, the effect that reduces coupling degradation further increases. As described above, a plurality of connection circuits may be used, and arrangement positions thereof are not limited to the positions shown in the drawings.

### Embodiment 3

FIG. 8 is a configuration diagram of a portable wireless terminal according to Embodiment 3 of the present invention.

In FIG. 8, the components common to FIGS. 1(a) to 1(c) will be referenced by the same reference numerals and signs, and description thereof will be omitted.

The portable wireless terminal shown in FIG. 8 includes a circuit board pattern 300 that interconnects the position of the first antenna element 150 close to the first impedance matching circuit 112 and the position of the second antenna element 151 close to the second impedance matching circuit 113. With such a configuration, by adjusting the length and the width of the pattern, it is possible to adjust the impedance of the mutual coupling between the antenna elements without using the circuit constants. As a result, it is possible to obtain the effect that reduces coupling degradation.

Although the present invention has been described in detail with reference to specific embodiments, it will be readily apparent to those skilled in the art that various modifications and variations can be made to the embodiments without departing from the spirit and scope of the present invention.

This application is based on Japanese Patent Application No. 2010-112851 filed on the 17th of May in 2010, which is incorporated herein by reference.

### INDUSTRIAL APPLICABILITY

The antenna device of the present invention and the portable wireless terminal equipped with the same are able to achieve an array antenna capable of obtaining characteristics of loose coupling in a wide frequency band, and are thus useful for the portable wireless terminals such as a mobile phone.

### REFERENCE SIGNS LIST

100 PORTABLE WIRELESS TERMINAL

101 CIRCUIT BOARD

102 FIRST WIRELESS CIRCUIT SECTION

103 SECOND WIRELESS CIRCUIT SECTION

104 FIRST POWER SUPPLY SECTION

105 SECOND POWER SUPPLY SECTION

106 FIRST CONDUCTOR PLATE

107 SECOND CONDUCTOR PLATE

108 THIRD CONDUCTOR PLATE

109 FOURTH CONDUCTOR PLATE

110 FIFTH CONDUCTOR PLATE

111 SIXTH CONDUCTOR PLATE

112 FIRST IMPEDANCE MATCHING CIRCUIT

113 SECOND IMPEDANCE MATCHING CIRCUIT

114 FIRST CONNECTION CIRCUIT

115 SECOND CONNECTION CIRCUIT

150 FIRST ANTENNA ELEMENT

151 SECOND ANTENNA ELEMENT

201 FIRST CONNECTION POSITION

202 SECOND CONNECTION POSITION

203 THIRD CONNECTION POSITION

300 CIRCUIT BOARD PATTERN

1. An antenna device comprising:
a casing;
a circuit board that is provided in the casing and has a ground pattern;
a first antenna element that includes a first conductor plate which is disposed in and near the casing and is conductive and substantially rectangular, a second conductor plate which shares one side of the first conductor plate in a widthwise direction thereof, is disposed on the first conductor plate at approximately 90 degrees, and is substantially rectangular, and a third conductor plate which shares the other side in the widthwise direction opposed to the one side of the second conductor plate shared with the first conductor plate, is disposed at approximately 90 degrees so as to be opposed to the first conductor plate, and is substantially rectangular, and supplied with electric power substantially from a corner of the circuit board;
a second antenna element that includes a fourth conductor plate which is disposed in and near the casing and is conductive and substantially rectangular, a fifth conductor plate which shares one side of the fourth conductor plate in a widthwise direction thereof, is disposed on the fourth conductor plate at approximately 90 degrees, and is substantially rectangular, and a sixth conductor plate which shares the other side in the widthwise direction opposed to the one side of the fifth conductor plate shared with the fourth conductor plate, is disposed at approximately 90 degrees so as to be opposed to the fourth conductor plate, and is substantially rectangular, and that is supplied with electric power substantially from a corner of the circuit board; and
a connection circuit that electrically interconnects the first antenna element and the second antenna element,
wherein the first antenna element and the second antenna element are disposed to be close to each other at a predetermined distance away from the ground pattern on the circuit board, and are electrically connected to a first power supply section and a second power supply section which are disposed at end portions of the circuit board, and
wherein the connection circuit is adjusted to cancel an impedance of mutual coupling between the first antenna element and the second antenna element in a range from a first frequency band to a second frequency band.

2. The antenna device according to claim 1, wherein:
the first antenna element is electrically connected to the first power supply section through a first impedance matching circuit, and
wherein the second antenna element is electrically connected to the second power supply section through a second impedance matching circuit.

3. The antenna device according to claim 1, wherein:
a part or the entirety of either one or both of the first antenna element and the second antenna element is formed as a copper foil pattern on a printed-circuit board.

4. The antenna device according to claim 1, wherein:
either one or both of the first antenna element and the second antenna element is formed of a substantially cylindrical conductor.

5. A portable wireless terminal comprising the antenna device according to claim 1.

6. A MIMO-capable portable wireless terminal comprising the antenna device according to claim 1.
